(19) United States
(12) Patent Application Publication
(10) Pub. No.: US 2011/0076034 A1
(43) Pub. Date: Mar. 31, 2011

(54) IDENTIFYING MACHINE, IMAGE FORMING APPARATUS, AND ROLLER IDENTIFYING METHOD

(75) Inventor: Tokihiko ISE, Shizuoka-ken (JP)

(73) Assignees: Kabushiki Kaisha Toshiba, Tokyo (JP); Toshiba Tech Kabushiki Kaisha, Tokyo (JP)

(21) Appl. No.: 12/877,787

(22) Filed: Sep. 8, 2010

Related U.S. Application Data
(60) Provisional application No. 61/246,482, filed on Sep. 28, 2009.

(51) Int. Cl. G03G 15/00

(52) U.S. Cl. 399/12

(57) ABSTRACT

An image forming apparatus includes a roller that should be identified, an indicator configured to rotate together with the roller, a sensor configured to come into contact with the indicator and read plural steps of the indicator, a storage configured to store an identification code, and a controller configured to compare the identification code read out from the storage and an output of the sensor.

### CROSS-REFERENCE TO RELATED APPLICATIONS

This application is based upon and claims the benefit of priority from the prior the U.S. Patent Application No. 61/246,482, filed on Sep. 28, 2009, and the entire contents of which are incorporated herein by reference.

### FIELD

Embodiments described herein relate generally to a roller identifying machine, an image forming apparatus, and a roller identifying method.

### BACKGROUND

Machine products provided to the market include rollers. Since these rollers are worn because of abrasion, the rollers are periodically replaced.

In these days, illegally-copied pirated products often appear on the market. These pirated products are often poor in quality.

Therefore, when pirated rollers are used in machine products instead of genuine product rollers, these machine products cannot keep expected quality during manufacturing. In the worst case, breakage of the machine products occurs. According to such a background, there is a demand for an apparatus that identifies whether rollers are authentic or not.

In regard to this point, a technique for causing an IC chip to store a code for identifying authenticity and sticking the IC chip to a roller is proposed.

However, the IC chip is expensive and leads to an increase in a price of the roller.

### BRIEF DESCRIPTION OF THE DRAWINGS

FIG. 1 is a diagram of the configuration of an image forming apparatus;

FIG. 2 is an external perspective view of a sensor;

FIG. 3 is a schematic side view of the configuration of the sensor;

FIG. 4 is a front view of a pickup mechanism in which the sensor is in a home position;

FIG. 5 is a front view of the pickup mechanism in which the sensor is in a roller detection position;

FIG. 6 is a diagram of the configuration of a sensor driving section;

FIG. 7 is a diagram for explaining the operation of the sensor driving section;

FIG. 8 is a sectional view of the pickup mechanism taken along line A-A shown in FIG. 4;

FIG. 9 is a sectional view of the pickup mechanism taken along line B-B shown in FIG. 5;

FIG. 10 is a perspective view of the sensor in the detection position;

FIG. 11 is a diagram of another shape of an irregular section;

FIG. 12 is a perspective view of a roller identifying machine configured to identify a roller when the roller is a photoconductive drum;

FIG. 13 is a top view of the photoconductive drum and the sensor;

FIG. 14 is a diagram of the photoconductive drum viewed from the direction of an arrow A in the figure;

FIG. 15 is a schematic diagram of the configuration of an image forming apparatus;

FIG. 16 is a diagram of irregularities of an indicator detected by the sensor;

FIG. 17 is a diagram of another example of the irregularities of the indicator detected by the sensor; and

FIG. 18 is a diagram of still another example of the irregularities of the indicator detected by the sensor.

### DETAILED DESCRIPTION

Throughout this specification, the embodiments and examples shown should be considered as exemplars, rather than limitations on the apparatus and methods of the present embodiments.

An embodiment of a roller identifying machine, an image forming apparatus, and a roller identifying method is explained in detail below with reference to the accompanying drawings. The image forming apparatus is a copying machine, an MFP (Multifunction Peripheral), or a printer.

An image forming apparatus 1 according to this embodiment includes an indicator having plural steps in a direction and configured to rotate together with a roller, an actuator configured to come into contact with the indicator, a sensor configured to detect displacement of the actuator in a direction, a storage configured to store a code, and a controller configured to identify the roller according to comparison of a displacement pattern of the actuator and the code.

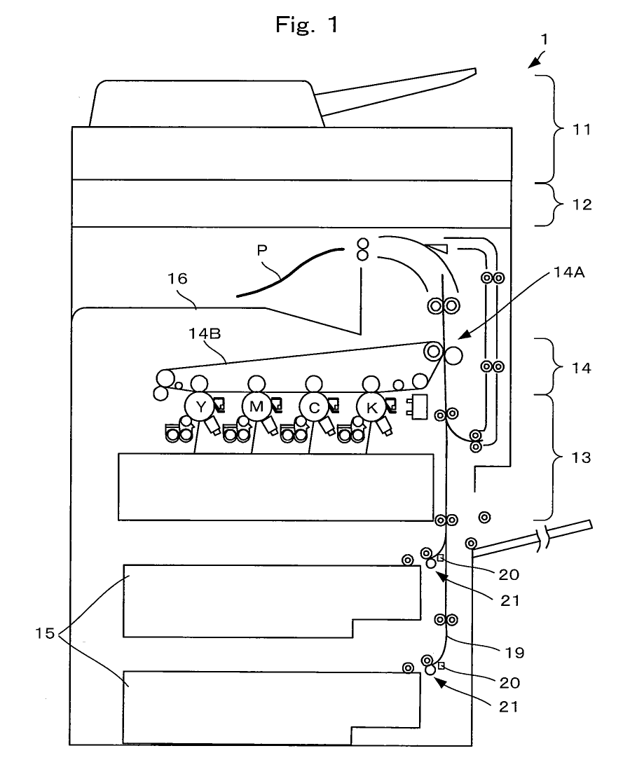

FIG. 1 is a diagram of the configuration of the image forming apparatus 1 according to this embodiment. As shown in FIG. 1, the image forming apparatus 1 includes an automatic document feeder 11, an image reading section 12, an image forming section 13, a transfer section 14, a recording medium conveying mechanism 19, and a paper feeding unit 15.

The image forming apparatus 1 includes, in an upper part of a main body, the automatic document feeder 11 provided to be openable and closable. The automatic document feeder 11 includes a document conveying mechanism configured to extract original documents from a paper feeding tray one by one and convey the original document to a paper discharge tray.

The automatic document feeder 11 conveys, with the document conveying mechanism, the original documents to a document reading section of the image reading section 12 one by one. It is also possible to open the automatic document feeder 11 and place an original document on a document table of the image reading section 12.

The image reading section 12 includes a carriage including an exposure lamp configured to expose an original document to light and a first reflection mirror, plural second reflection mirrors locked to a main body frame of the image forming apparatus 1, a lens block, and a CCD (Charge Coupled Device) of an image reading sensor.

The carriage stands still in the document reading section or reciprocatingly moves under the document table to reflect the light of the exposure lamp, which is reflected by the original document, to the first reflection mirror. The plural second reflection mirrors reflect the reflected light of the first reflection mirror to the lens block. The lens block outputs this reflected light to the CCD. The CCD converts incident light into an electric signal and outputs the electric signal to the image forming section 13 as an image signal.

The image forming section 13 includes, for each of yellow Y, magenta M, cyan C, and black K, a laser irradiating unit, a photoconductive drum as an electrostatic latent image bearing member, and a developer supplying unit.

The laser irradiating unit irradiates a laser beam on the photoconductive drum on the basis of the image signal and forms an electrostatic latent image on the photoconductive drum. The developer supplying unit supplies a developer to the photoconductive drum and forms a developer image from the electrostatic latent image.

The recording medium conveying mechanism 19 includes, most upstream on the paper feeding unit 15 side, a pickup mechanism 21 configured to extract recording media one by one.

The pickup mechanism 21 extracts the recording media from the paper feeding unit 15 one by one and passes the recording medium to the recording medium conveying mechanism 19. The recording medium conveying mechanism 19 conveys the recording medium to the transfer section 14.

The transfer section 14 includes a transfer belt 14B, a transfer roller, and a fuser 14A. The transfer belt 14B as an image bearing member receives the transfer of the developer image on the photoconductive drum and bears the developer image. The transfer roller applies voltage to the developer image on the transfer belt 14B and transfers the developer image onto the recording medium conveyed to the transfer roller. The fuser 14A heats and presses the developer image and fixes the developer image on the recording medium.

The image forming apparatus 1 includes, along a recording medium conveying path of the recording medium conveying mechanism 19, a sensor 20 configured to detect the thickness of the recording medium. The sensor 20 is provided in the pickup mechanism 21.

A recording medium P discharged from a paper discharge port is stacked on a paper discharge tray 16, which is a carrying section configured to carry a recording medium.

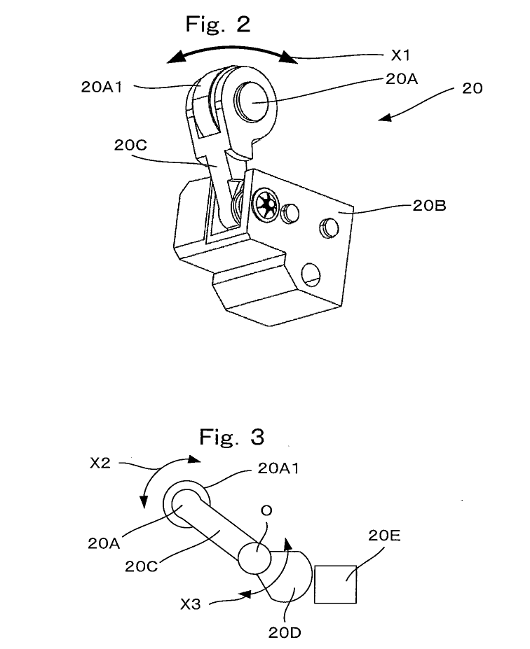

FIG. 2 is an external perspective view of the sensor 20. As shown in FIG. 2, the sensor 20 includes a roller section 20A, a sensor main body section 20B, and an actuator 20C.

The roller section 20A includes a roller 20A1 at one end. The sensor 20 includes the roller section 20A such that the other end of the roller section 20A can pivot in an arrow X1 direction with respect to the sensor main body section 20B via the actuator 20C.

The sensor 20 detects the thickness of a recording medium with, for example, a magnetic sensor. The sensor 20 has, at the base of the roller section 20A, a permanent magnet that is displaced according to the pivoting of the roller section 20A. The magnetic sensor of the sensor main body section 20B detects a change in magnetic force.

Electric resistance of the magnetic sensor changes according to the magnetic force. The image forming apparatus 1 detects the change in the electric resistance to thereby detect the thickness of the recording medium.

FIG. 3 is a schematic side view of the configuration of the sensor 20. As shown in FIG. 3, the actuator 20C has the roller section 20A at the distal end thereof and has a magnet 20D at the other end. The sensor 20 includes the actuator 20C such that the base of the actuator 20C can pivot around a pin O with respect to a frame of the sensor 20. The sensor 20 includes a magnetic sensor 20E on the frame.

When the roller section 20A pivots in a direction of an arrow X2, the magnet 20D pivots in a direction of an arrow X3 around the pin O. The magnetic sensor 20E detects a change in a magnetic field of the magnet 20D.

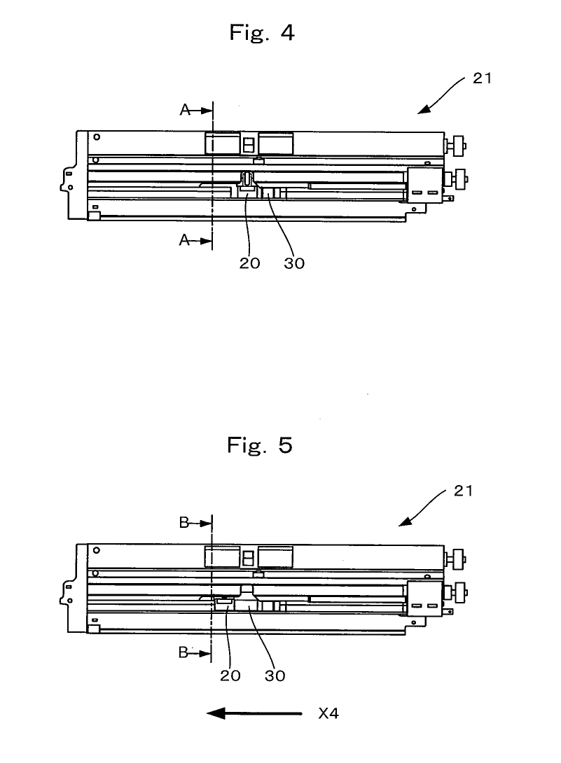

FIG. 4 is a front view of the pickup mechanism 21 in which the sensor 20 is in a home position. As shown in FIG. 4, the pickup mechanism 21 includes a sensor driving section 30 configured to displace the position of the sensor 20.

When the sensor 20 is in the home position, the sensor 20 detects the thickness of a recording medium conveyed to the sensor 20.

FIG. 5 is a front view of the pickup mechanism 21 in which the sensor 20 is in a roller detection position. As shown in FIG. 5, the sensor driving section 30 displaces the sensor 20 in a direction of an arrow X4 and pivots the sensor 20 in a roller axis direction.

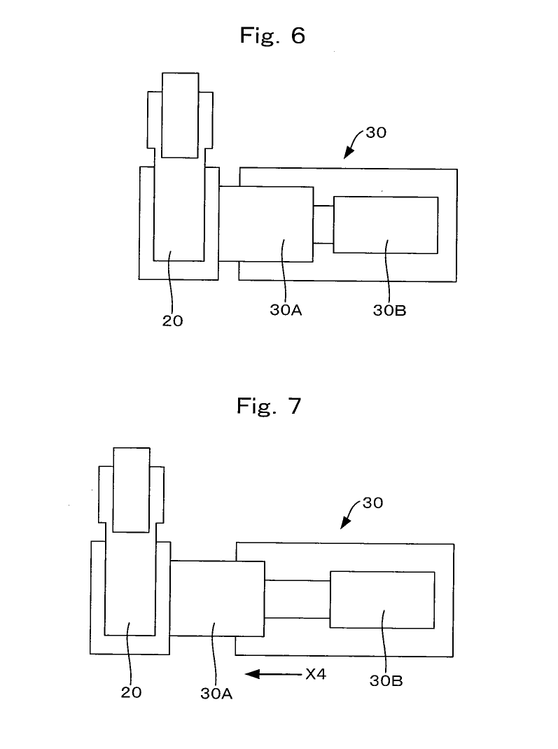

FIG. 6 is a diagram of the configuration of the sensor driving section 30. As shown in FIG. 6, the sensor driving section 30 includes a motor 30A connected to the frame of the sensor 20 and configured to pivot the sensor 20 and a solenoid 30B configured to displace the motor 30A in the horizontal direction together with the sensor 20.

FIG. 7 is a diagram for explaining the operation of the sensor driving section 30. As shown in FIG. 7, the solenoid 30B displaces the motor 30A in the arrow X4 direction, which is the horizontal direction, together with the sensor 20. The motor 30A pivots the sensor 20.

The sensor driving section 30 returns the displaced sensor 20 to the home position using the motor 30A and the solenoid 30B.

FIG. 8 is a sectional view of the pickup mechanism 21 taken along line A-A shown in FIG. 4. As shown in FIG. 8, the pickup mechanism 21 includes a roller 21B. The roller 21B includes a cylindrical indicator 21C that shares a rotation axis with the roller 21B.

When the sensor 20 is in the home position, the sensor 20 brings the roller section 20A into contact with a guide 21A. The sensor 20 detects the thickness of a recording medium conveyed between the guide 21A and the roller section 20A.

The image forming section 13 changes an image forming method according to the thickness of the recording medium detected by the sensor 20. For example, if the thickness of the recording medium detected by the sensor 20 is larger than a standard, the image forming section 13 forms an image to have density higher than standard density. For example, if the thickness of the recording medium detected by the sensor 20 is larger than the standard, the image forming section 13 fixes a toner image at temperature higher than standard fixing temperature. For example, if the thickness of the recording medium detected by the sensor 20 is larger than the standard, the image forming section 13 transfers the toner image onto the recording medium at voltage higher than standard transfer voltage. For example, if the thickness of the recording medium detected by the sensor 20 is larger than the standard, the image forming section 13 conveys the recording medium at speed lower than standard conveying speed.

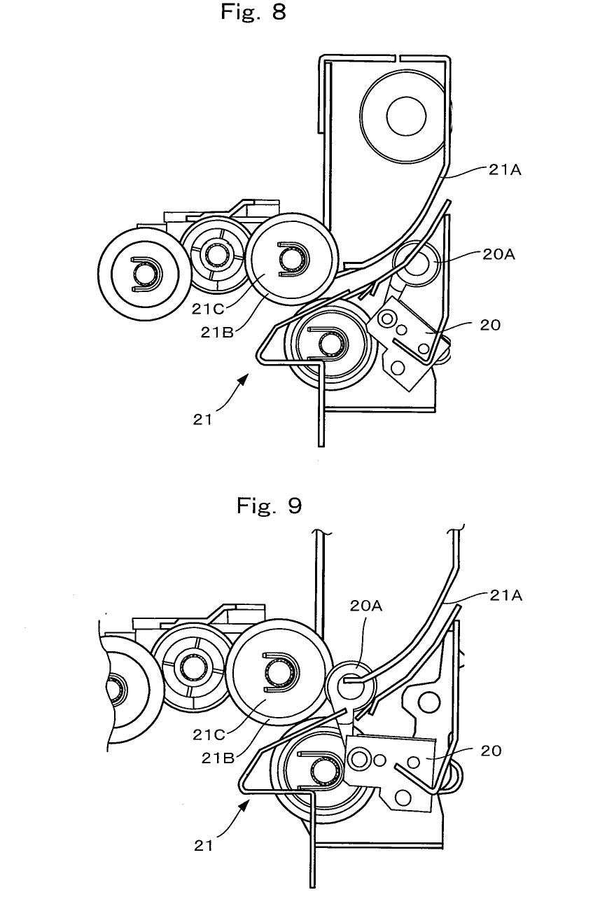

FIG. 9 is a sectional view of the pickup mechanism 21 taken along line B-B shown in FIG. 5. As shown in FIG. 9, after being displaced in the horizontal direction by the solenoid 30B of the sensor driving section 30, the sensor 20 is pivoted by the motor 30A such that the roller section 20A comes into contact with the indicator 21C.

The guide 21A has a cutout in a position corresponding to the indicator 21C. The roller section 20A of the sensor 20 comes into contact with the indicator 21C through the cutout.

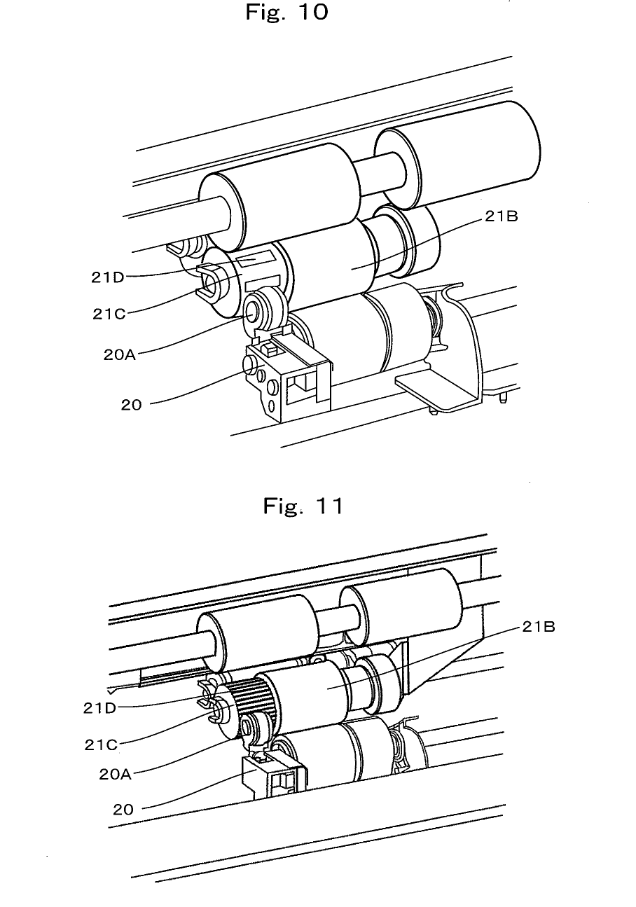

FIG. 10 is a perspective view of the sensor 20 in the detection position. As shown in FIG. 10, the roller 21B includes the cylindrical indicator 21C that shares the rotation axis with the roller 21B. The indicator 21C has plural steps in a direction and rotates together with the roller 21B. In other words, the indicator 21C has the rotation axis same as that of the roller 21B and has an irregular section 21D parallel to the rotation axis of the roller 21B as the plural steps. The indicator 21C rotates around the rotation axis of the roller 21B.

The indicator 21C includes the irregular section 21D on the side thereof. The irregular section 21D may be formed by cutting the indicator 21C, may be formed by sticking a seal, or may be formed by injection molding.

The indicator 21C includes the irregular section 21D parallel to the rotation axis. The roller section 20A comes into contact with the irregular section 21D. The sensor 20 detects irregularities of the irregular section 21D.

The sensor 20 detects the thickness of the irregular section 21D according to displacement of the actuator 20C in the thickness direction of the irregular section 21D. The sensor 20 includes the roller section 20A such that a pivoting direction of the roller section 20A coincides with the height direction of the thickness of the irregular section 21D with which the roller section 20A is in contact. A rotation axis of the roller section 20A is parallel to the rotation axis of the indicator 21C. Therefore, the sensor 20 can detect the irregularities of the irregular section 21D when the indicator 21C rotates.

FIG. 11 is a diagram of another shape of the irregular section 21D. As shown in FIG. 11, the indicator 21C can also include the irregular section 21D including a large number of irregularities.

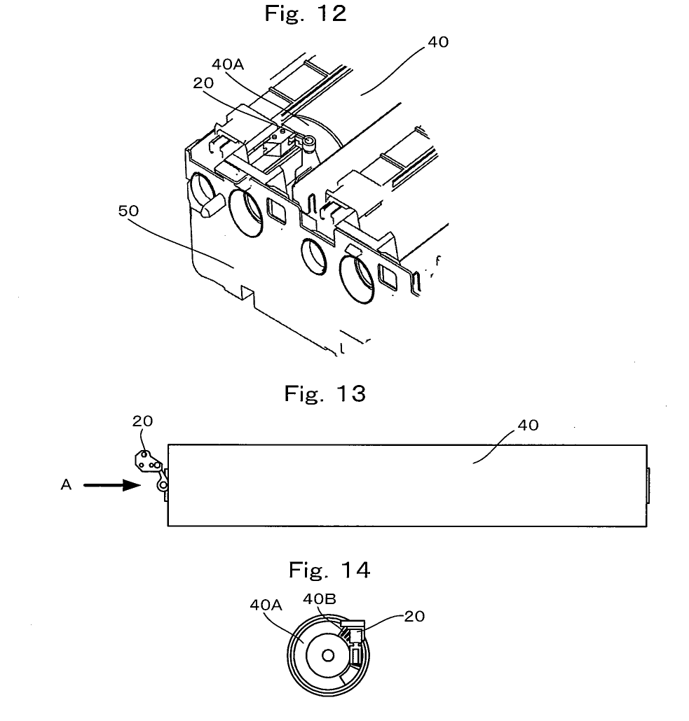

FIG. 12 is a perspective view of a roller identifying machine configured to identify a roller when the roller is a photoconductive drum 40. As shown in FIG. 12, a process unit cartridge 50 houses the photoconductive drum 40. The photoconductive drum 40 includes an indicator 40A on an end face thereof.

The process unit cartridge 50 includes the sensor 20 such that the roller section 20A comes in contact with the indicator 40A.

FIG. 13 is a top view of the photoconductive drum and the sensor 20. FIG. 14 is a diagram of the photoconductive drum 40 viewed from a direction of an arrow A shown in FIG. 13. As shown in FIGS. 13 and 14, the photoconductive drum 40 as the roller includes the indicator 40A on the end face of the photoconductive drum 40.

The indicator 40A includes an irregular section 40B. The irregular section 40B may be formed by cutting the indicator 40A, may be formed by sticking a seal, or may be formed by injection molding. The roller section 20A comes into contact with the irregular section 40B. The sensor 20 detects irregularities of the irregular section 40B.

The indicator 40A includes the irregular section 40B radially with respect to the rotation axis thereof. The indicator 40A has plural steps in a direction and rotates together with the photoconductive drum 40. The sensor 20 detects the thickness of the irregular section 40B according to displacement of the actuator 20C in the thickness direction of the irregular section 40B. The sensor 20 includes the roller section 20A such that a pivoting direction of the roller section 20A coincides with the height direction of the thickness of the irregular section 40B with which the roller section 20A is in contact. The rotation axis of the roller section 20A is perpendicular to the rotation axis of the indicator 40A. The indicator 40A rotates around a rotation axis of the photoconductive drum 40. Therefore, the sensor 20 can detect the irregularities of the irregular section 40B when the indicator 40A rotates.

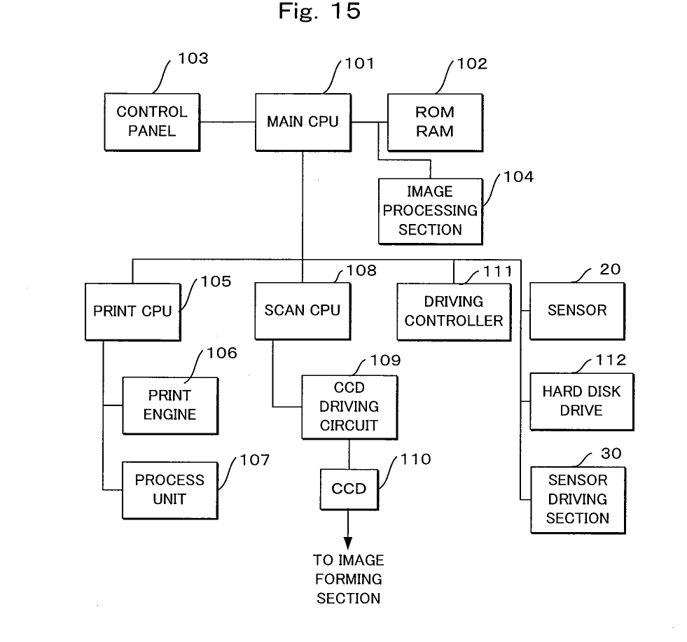

FIG. 15 is a schematic diagram of the configuration of the image forming apparatus 1. As shown in FIG. 15, the image forming apparatus 1 includes a main CPU 101 as a controller configured to collectively control the entire image forming apparatus 1, a control panel 103 as a display device connected to the main CPU 101, a ROM and RAM 102 as a storage, and an image processing section 104 configured to perform image processing.

The main CPU 101 is connected to a print CPU 105 configured to control sections of an image forming system, a scan CPU 108 configured to control sections of an image reading system, and a driving controller 111 configured to control a driving section.

The print CPU 105 controls a print engine 106 configured to form an electrostatic latent image on the photoconductive drum 40 and a process unit 107 configured to form a developer image. The print CPU 105 determines the thickness of a recording medium according to an output from the sensor 20 and controls the print engine 106 and the process unit 107 on the basis of the thickness of the recording medium.

The scan CPU 108 controls a CCD driving circuit 109 configured to drive a CCD 110. A signal from the CCD 110 is output to the image forming section.

The main CPU 101 is connected to the sensor 20, the sensor driving section 30, and a hard disk drive 112 as a storage configured to store an identification code.

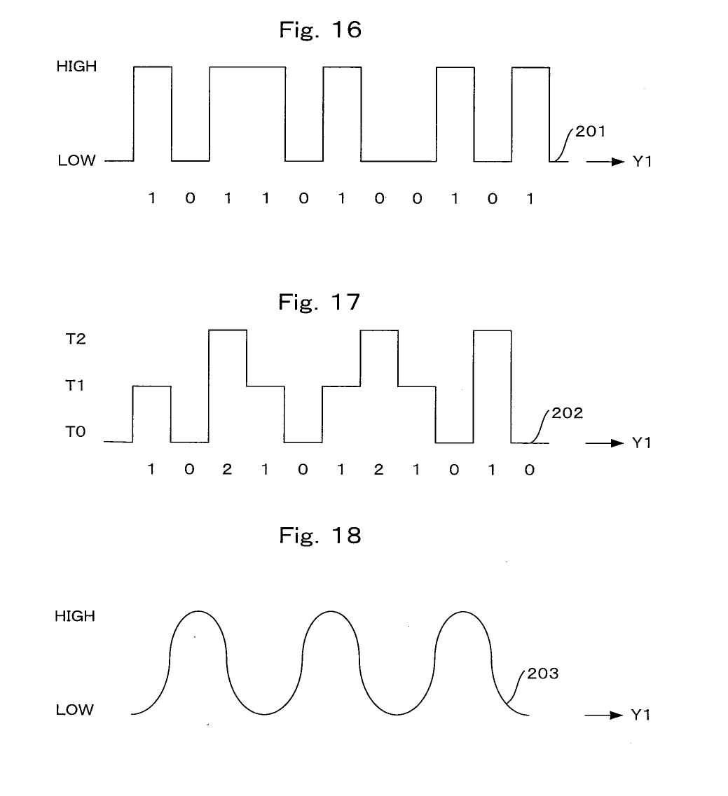

FIG. 16 is a diagram of irregularities of the indicators 21C and 40A detected by the sensor 20. A graph 201 indicates a state of irregularities in a rotating direction Y1.

The controller displaces the sensor 20 to the detection position and rotates a roller that should be identified. Subsequently, the controller replaces irregularities of the indicators 21C and 40A with numerical values according to an output of the sensor 20.

As shown in FIG. 16, the controller replaces the irregularities of the indicators 21C and 40A with a numerical value “1” when the irregularities are HIGH and replaces the irregularities with a numerical value “0” when the irregularities are LOW. In the case of FIG. 16, the controller identifies “10110100101”.

Since the roller rotates, it is necessary to identify a start position of a code. Therefore, first 4 bits are set as a start code. When the controller identifies a start code “1011”, the controller reads out a data code “0100101” following the start code “1011”.

Subsequently, the controller reads out the identification code stored in advance from the hard disk drive 112.

The controller compares a data code, which is a displacement pattern of the actuator 20C, and the identification code. If the data code and the identification code coincide with each other, the controller determines that the roller is a genuine component and shifts to a normal operation. If the data code and the identification code do not coincide with each other, the controller determines that the roller is a pirated component, stops the operation of the image forming apparatus 1, and displays, on the control panel 103, indication urging a user to use the genuine component.

FIG. 17 is a diagram of another example of the irregularities of the indicators 21C and 40A detected by the sensor 20. A graph 202 indicates a state of the irregularities in the rotating direction Y1.

In the example shown in FIG. 16, the numerical values are binary numbers. However, the numerical values may be ternary numbers. As shown in FIG. 17, the controller replaces the irregularities of the indicators 21C and 40A with a numerical value “0” when the height of the irregularities is T0, replaces the irregularities with a numerical value “1” when the height is T1, and replaces the irregularities with a numerical value “2” when the height is T2.

When a start code is “1021”, the controller reads out a data code “0121010”.

Subsequently, the controller reads out the identification code stored in advance from the hard disk drive 112.

The controller compares the data code with the identification code. If the data code and the identification code coincide with each other, the controller determines that the roller is a genuine component and shifts to the normal operation. If the data code and the identification code do not coincide with each other, the controller determines that the roller is a pirated component, stops the operation of the image forming apparatus 1, and displays, on the control panel 103, indication urging the user to use the genuine component.

FIG. 18 is a diagram of still another example of the irregularities of the indicators 21C and 40A detected by the sensor 20. A graph 203 indicates a state of the irregularities in the rotating direction Y1.

In the examples shown in FIGS. 16 and 17, the irregularities are converted into numerical values. As shown in FIG. 18, the irregularities of the indicators 21C and 40A may smoothly change and indicate a fixed frequency.

The controller displaces the sensor 20 to the detection position and rotates the roller that should be identified. The controller calculates a frequency of the irregularities of the indicators 21C and 40A from an output of the sensor 20.

Subsequently, the controller reads out the identification code stored in advance from the hard disk drive 112.

The controller compares the calculated frequency, which is a displacement pattern of the actuator 20C, and the identification code. If the frequency and the identification code coincide with each other, the controller determines that the roller is a genuine component and shifts to the normal operation. If the frequency and the identification code do not coincide with each other, the controller determines that the roller is a pirated component, stops the operation of the image forming apparatus 1, and displays, on the control panel 103, indication urging the user to use the genuine component.

As explained above, the image forming apparatus 1 according to this embodiment includes the roller that should be identified, the indicators 21C and 40A configured to rotate together with the roller, the sensor 20 configured to come into contact with the indicators 21C and 40A and read irregularities of the indicators 21C and 40A, the storage configured to store the identification code, and the controller configured to compare the identification code read out from the storage and an output of the sensor 20.

Therefore, there is an effect that it is possible to inexpensively manufacture the roller that should be identified and it is possible to highly accurately identify authenticity of the roller.

While certain embodiments have been described, these embodiments have been presented by way of example only, and are not intended to limit the scope of the inventions. Indeed, the novel methods and apparatuses described herein may be embodied in a variety of other forms; furthermore, various omissions, substitutions and changes in the form of the methods and systems described herein may be made without departing from the spirit of the inventions. The accompanying claims and their equivalents are indeed to cover such forms or modifications as would fall within the scope and spirit of the inventions.

1. A identifying machine configured to identify a roller, comprising:
an indicator including plural steps in a direction, configured to rotate together with the roller;
an actuator configured to contact with the indicator;
a sensor configured to detect displacement of the actuator in the direction;
a storage configured to store a code; and
a controller configured to identify the roller according to comparison of a displacement pattern of the actuator and the code.

2. The machine according to claim 1, wherein the indicator rotating around a rotation axis of the roller comprises the plural steps parallel to the rotation axis of the roller.

3. The machine according to claim 1, wherein the indicator comprises the plural steps on an end face of the roller.

4. The machine according to claim 1, wherein the code includes a start code and a data code following the start code.

5. The machine according to claim 1, wherein the displacement pattern of the actuator and the code are frequencies.

6. The machine according to claim 1, wherein the sensor includes:
an actuator configured to pivot according to height of the steps;
a magnet displaced according to the pivoting of the actuator; and
a magnetic sensor configured to output an output corresponding to a change in a magnetic field of the magnet.

7. The machine according to claim 6, wherein the actuator takes a first position where the actuator is in contact with the steps and a second position where the actuator is in contact with a sheet conveyed by the roller.

8. An image forming apparatus comprising:
an image forming section configured to form an image on a recording medium;
a roller configured to convey the recording medium;
an indicator including plural steps in a direction and configured to rotate together with the roller;
an actuator configured to contact with the indicator;
a sensor configured to detect displacement of the actuator in the direction;
a storage configured to store a code; and
a controller configured to identify the roller according to comparison of a displacement pattern of the actuator and the code.

9. The apparatus according to claim 8, wherein the indicator rotating around a rotation axis of the roller comprises the plural steps parallel to the rotation axis of the roller.

10. The apparatus according to claim 8, wherein the code includes a start code and a data code following the start code.

11. The apparatus according to claim 8, wherein the displacement pattern of the actuator and the code are frequencies.

12. The apparatus according to claim 8, wherein the sensor includes:
an actuator configured to pivot according to height of the steps;
a magnet displaced according to the pivoting of the actuator; and
a magnetic sensor configured to output an output corresponding to a change in a magnetic field of the magnet.

13. The apparatus according to claim 12, wherein the actuator takes a first position where the actuator is in contact with the steps and a second position where the actuator is in contact with a sheet conveyed by the roller.

14. The apparatus according to claim 13, wherein the image forming section changes an image forming method according to thickness of the recording medium detected by the sensor in the second position.

15. The apparatus according to claim 8, wherein the image forming section includes:
an electrostatic latent image bearing member configured to bear an electrostatic latent image;
a developer supplying unit configured to supply a developer for image formation to the electrostatic latent image;
an image bearing member configured to bear a developer image; and
a fuser configured to fix the developer image transferred onto the recording medium from the image bearing member, and the roller is the electrostatic latent image bearing member.

16. The apparatus according to claim 8, further comprising a sensor driving section configured to displace the sensor, wherein
the sensor driving section displaces, when the sensor detects the plural steps, the sensor such that a roller section of the sensor comes into contact with the plural steps of the indicator.

17. A roller identifying method comprising a controller identifying a roller by comparing a displacement pattern of an actuator, which is detected by a sensor, displaced according to plural steps of an indicator that rotates together with the roller and a code read out from a storage.

18. The method according to claim 17, wherein the sensor detects the plural steps of the indicator that rotates around a rotation axis of the roller, the plural steps being parallel to the rotation axis of the roller.

19. The method according to claim 17, wherein the sensor detects the plural steps on an end face of the roller.

20. The method according to claim 17, wherein the sensor outputs an output corresponding to a change in a magnetic field of a magnet displaced by the actuator that pivots according to height of the steps.
